(19) United States
(12) Patent Application Publication
(10) Pub. No.: US 2026/0264753 A1
(43) Pub. Date: Sep. 10, 2026

(54) OFFSET REAR WHEEL STEERING SYSTEM

(71) Applicant: FCA US LLC, Auburn Hills, MI (US)

(72) Inventors: Christopher M Greene, Auburn Hills, MI (US); Jonathan Baumgarten, Auburn Hills, MI (US)

(21) Appl. No.: 19/073,543

(22) Filed: Mar. 7, 2025

(51) Int. Cl. B62D 7/15; B62D 7/20

(52) U.S. Cl. CPC B62D 7/1545; B62D 7/20

(57) ABSTRACT

A vehicle includes a support structure, first and second rear wheel mounts, a suspension assembly coupled to the wheel mounts, and a rear wheel steering assembly. A steering assembly actuator is coupled to the support structure, a first steering link coupled to the first wheel mount and to a first pivot member, a second steering link coupled the second wheel mount and to a second pivot member. The pivot members are separately connected to the actuator and are rotatable about separate pivots, and each pivot is located between the connections of the associated steering link and the actuator to the pivot member. The actuator is located spaced in a fore-aft direction from an axis of rotation of the rear wheels, and the pivot members are oriented to space a distance in the fore-aft direction between an axis of movement of the actuator and the steering links.

### FIELD

The present disclosure relates to a rear wheel steering system with an actuator that is offset relative to the rear wheels.

### BACKGROUND

Some vehicles include rear wheels that are movable to cause some rear wheel steering of the vehicle. An actuator is used to change the steering angle of the rear wheels when desired. The vehicle also includes various powertrain components, such as an electric motor, combustion engine, differentials, power transfer units and the like. Some power train components are located between the rear wheels and consume space in which the actuator and related components could be mounted.

### SUMMARY

In at least some implementations, a vehicle includes a support structure, a first wheel mount and a second wheel mount each adapted to receive a separate one of two rear wheels of the vehicle for rotation about an axis of rotation, a rear suspension assembly coupled between the support structure and the first wheel mount and the second wheel mount, and a rear wheel steering assembly coupled to the support structure and to the first wheel mount and the second wheel mount. The rear wheel steering assembly includes an actuator coupled to the support structure, a first steering link coupled to the first wheel mount and to a first pivot member, a second steering link coupled the second wheel mount and to a second pivot member. The first pivot member and the second pivot member are separately connected to the actuator and are rotatable about separate pivots, and each pivot is located between the connections of the associated steering link and the actuator to the pivot member. The actuator is coupled to the support structure at a location that is spaced in a fore-aft direction from the axis of rotation and the pivot members are oriented to space a distance in the fore-aft direction between an axis of movement of the actuator and the steering links. And the actuator is operable to change the angle of the first wheel mount and the second wheel mount relative to the support structure to provide rear wheel steering.

In at least some implementations, the actuator is coupled to the support structure at a location that is spaced rearwardly from the axis of rotation relative to the fore-aft direction. In at least some implementations, the actuator is a linear actuator and the axis of movement extends in a cross-car direction that extends between a left side and a right side of the vehicle, and is perpendicular to the fore-aft direction. In at least some implementations, the first pivot member is driven for rotation about a first pivot axis, the second pivot member is driven for rotation about a second pivot axis, and the first pivot axis and the second pivot axis are both perpendicular to the actuator axis of movement.

In at least some implementations, the first pivot axis and the second pivot axis are oriented perpendicular to the cross-car direction. In at least some implementations, the first steering link is connected to the first pivot member at a location forward of the first pivot axis relative to the fore-aft direction, and the actuator is coupled to the first pivot member at a location rearward of the first pivot axis.

In at least some implementations, the first steering link is coupled to the first wheel mount at a location rearward of the axis of rotation of the first wheel mount, and the second steering link is coupled to the second wheel mount at a location rearward of the axis of rotation of the second wheel mount.

In at least some implementations, the support structure includes a left side rail extending in the fore-aft direction, a right side rail extending in the fore-aft direction, and a rear rail extending in the cross-car direction, and the rear suspension assembly includes a first suspension assembly having at least one first suspension link coupled to the left side rail and the first wheel mount. The rear suspension assembly includes a second suspension assembly having at least one second suspension link coupled to the right side rail and the second wheel mount, and wherein the actuator is coupled to the rear rail at a location spaced from a line connecting a center of rotation of the first wheel mount and a center of rotation of the second wheel mount.

In at least some implementations, a powertrain component carried by the support structure forward of the actuator. In at least some implementations, the powertrain component is one or more than one traction motor that is coupled to the first wheel mount via a first shaft to drivingly rotate the first wheel mount, and the one or more than one traction motor is coupled to the second wheel mount via a second shaft to drivingly rotate the second wheel mount.

In at least some implementations, the left side rail, the right side rail and the rear rail are integrated into a cradle, a cavity is defined at least partially by the rails and a powertrain component is received at least partially within the cavity and forward of the actuator.

In at least some implementations, a bracket that is coupled to the support structure on opposite sides of the first pivot axis, and a pivot mount is coupled to the first bracket and defines the first pivot axis, and the first pivot member rotates relative to the bracket and in a space between the bracket and the support structure. In at least some implementations, the pivot mount extends through an opening in the pivot member, one end of the pivot mount is coupled to the support structure and another end of the pivot mount is coupled to the bracket.

In at least some implementations, a vehicle includes a support structure, first and second wheel mounts, a power train component, a rear suspension assembly and a rear wheel steering assembly. The support structure has a front rail, a rear rail, a left side rail between the front rail and the rear rail, and a left side rail between the front rail and the rear rail and spaced in a cross-car direction from the left side rail. The first wheel mount and second wheel mount are each adapted to receive a separate one of two rear wheels of the vehicle for rotation about an axis of rotation. The powertrain component is coupled to the support structure and to the first wheel mount via a first shaft that rotates with the first wheel mount, and to the second wheel mount via a second shaft that rotates with the second wheel mount. The rear suspension assembly is coupled between the support structure and the first wheel mount and the second wheel mount. And the rear wheel steering assembly is coupled to the support structure and to the first wheel mount and the second wheel mount. The rear wheel steering assembly includes a linear actuator coupled to the support structure, a first steering link coupled to the first wheel mount and to a first pivot member, and a second steering link coupled the second wheel mount and to a second pivot member. The first pivot member and the second pivot member are separately connected to the linear actuator and are rotatable about separate pivots, each pivot is located between the connections of the associated steering link and the linear actuator to the pivot member. The linear actuator is coupled to the support structure at a location that is spaced rearwardly from the power train component in a fore-aft direction, the pivot members are oriented to span a distance in the fore-aft direction between an axis of movement of the linear actuator and the steering links, and the linear actuator is operable to change the angle of the first wheel mount and the second wheel mount relative to the support structure to provide rear wheel steering.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a top perspective view of part of a vehicle showing a rear axle assembly, a rear wheel suspension and a rear wheel steering assembly, and an electric traction motor mounted at the rear axle;

FIG. 2 is a top perspective view like FIG. 1 with the traction motor removed;

FIG. 3 is a bottom view of the assemblies shown in FIG. 1 showing a linkage assembly of the rear wheel steering assembly;

FIG. 4 is a fragmentary bottom view showing part of the linkage of the rear wheel steering assembly; and

FIG. 5 is a perspective view showing part of the linkage of the rear wheel steering assembly.

### DETAILED DESCRIPTION

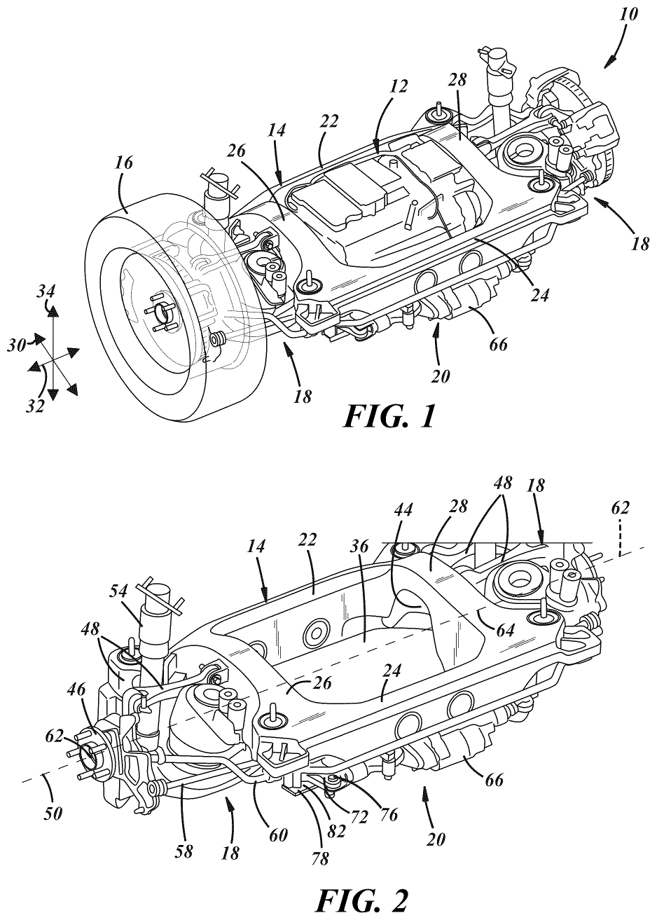

Referring in more detail to the drawings, FIG. 1 illustrates a rear wheel mounting and suspension assembly 10, and some related components for a motor vehicle. In the example shown, one or more electric traction motors 12 are mounted to a cradle 14 that is connected to a vehicle support structure or frame. The traction motor 12 drives the rear wheels 16 (one is shown in FIG. 1) of the vehicle to propel the vehicle along the ground. Each wheel 16 is mounted to the cradle 14 by separate independent suspension assemblies 18 each having multiple links and related components to enable controlled, relative movement of the wheels 16 relative to the cradle 14 and motor 12. As set forth in more detail below, the vehicle also includes a rear wheel steering assembly 20 by which a steering angle of the rear wheels 16 may be changed.

The cradle 14 may be of any construction and arrangement suitable to support at least part of the electric motor 12 and enable connection and support of the suspension assemblies 18. In the example shown, the cradle 14 is a unitary body having peripheral, interconnected metal rails. Referring to FIG. 2, the cradle 14 rails include a front rail 22 and a rear rail 24 that are each connected to a left side rail 26 and a right side rail 28. The front and rear rails 22, 24 are spaced apart in a fore-aft direction that extends between the front and rear ends of the vehicle (and is shown by arrow 30 in FIG. 1), and the left and right side rails 26, 28 are spaced apart in a cross-car direction that extends between the left and right sides of the vehicle (and is shown by arrow 32 in FIG. 1). Further, the rails may have a thickness in the vertical direction (shown by arrow 34) which is parallel to the direction of gravity and extends between a top and a bottom of the vehicle (e.g. perpendicular to the ground on which the tires are received). The rails may be separately formed components that are welded and or bolted together, or they may be define within a unitary structure, such as a casting, as shown in FIGS. 1-4. The rails are spaced apart and define an open interior cavity 36 in which the motor 12 is received.

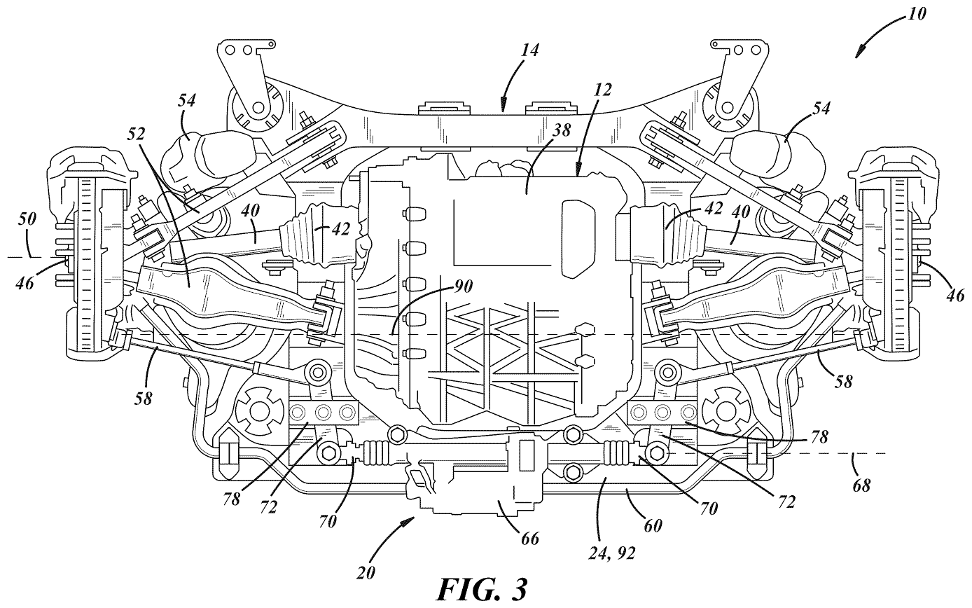

Referring to FIG. 3, the motor 12 may be of any desired size and construction suitable to provide motive power to drive the rear wheels 16 of the vehicle and to be received at least partly in the cavity 36. The motor 12 may be received within a housing 38 that is coupled to the cradle 14, and may include or be coupled to suitable gears, a source of electric power and suitable control electronics. The motor 12 may be coupled to the wheels 16, to drivingly rotate the wheels 16, through a pair of side shafts 40 and suitable rotating joints 42 that accommodate suspension travel of the wheels 16, such as constant velocity joints. The side shafts 40 may extend through openings or recesses 44 (FIG. 2) in the left and right side rails 26, 28 of the cradle 14. The vehicle may include one or more other motors for the front wheels of the vehicle, and/or a combustion engine, if desired.

Each member of the suspension assembly 18 is coupled between the cradle 14, or other vehicle support structure, and wheel mounts 46 for the rear wheels (i.e. a first wheel mount for the left rear wheel and a second wheel mount for the right rear wheel). The suspension assemblies 18 permit limited movement of the wheel mounts 46 relative to the support structures. Different suspension arrangements may be used and the embodiment shown in the drawings is one, non-limiting example.

In this example, each suspension assembly 18 includes one or more upper links 48 (FIG. 2) pivotably coupled to a respective one of the wheel mounts 46 above an axis of rotation 50 of the wheel mount 46, one or more lower links 52 (FIG. 3) pivotably coupled at or near the bottom of the cradle 14 to the wheel mount 46 below the axis 50, one or more shock absorbers 54, and a steering link 58 coupled to the wheel mount 46 offset from the axis 50. A torsion bar 60 may be connected at opposite ends to both wheel mounts 46 and to the cradle 14. To permit a controlled, suspension damped movement of the rear wheels 16, the links are coupled to the wheel mounts 46 at different locations and different angles, and permit limited movement of the wheel mounts 46 in different directions or at different angles. The steering links 58 are part of the rear wheel steering assembly 20 and are arranged to drivingly change a toe or steering angle of the rear wheels 16 as set forth in more detail below. Each wheel mount 46 rotates about a respective axis 50 on which is a center of rotation 62, which may be a point at the intersection of a center of mass of the wheel mount 46 and the axis of rotation 50. The wheel mounts 46 may be angled and may move in use such that the wheel mounts 46 are not coaxial, and an imaginary line 64 can be drawn between the center of rotation 62 of each wheel mount 46.

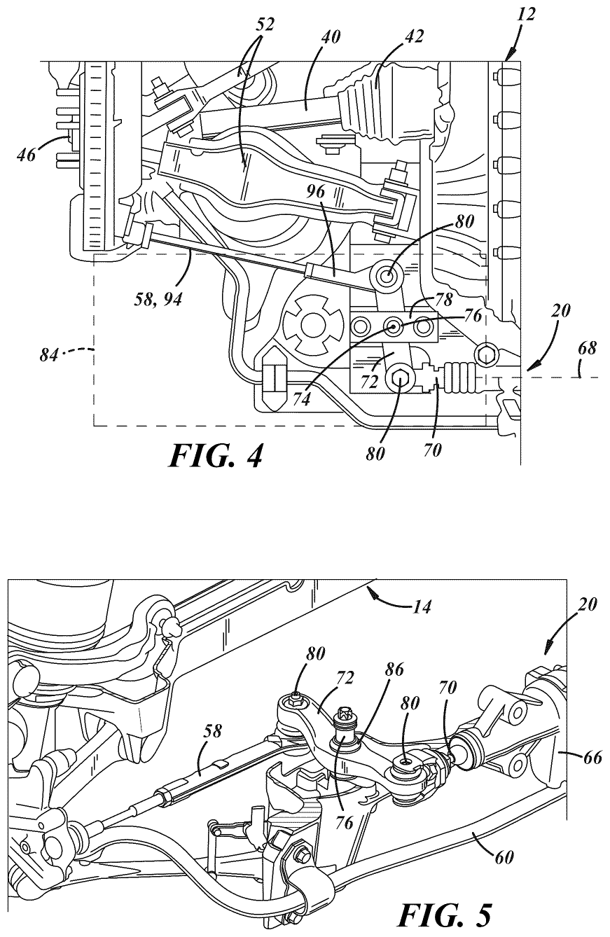

The rear wheel steering assembly 20 includes an actuator 66 coupled to the steering links 58 to drive the steering links 58 and change the steering angle of the rear wheels 16 of the vehicle. The actuator 66 may be a linear actuator arranged to drive output members 70 along an actuator line or axis of movement 68 (FIGS. 3 and 4). By way of some non-limiting examples, the actuator 66 may include a motor that drives one or more gears to cause the desired motion, a ball screw mechanism, or a pneumatic or hydraulic cylinder. The actuator 66 may be operable to drive the output members 70 (e.g. a nut of a ball screw, a piston/rod of a cylinder, etc) in opposite directions.

To cause a rear wheel steering angle change, the output members 70, which may be links or rods driven axially by the actuator 66, are each connected at their opposite ends to a respective pivot member 72 at a location spaced from a pivot axis 74 of the pivot member 72. Thus, when the output members 70 are axially driven by the actuator 66, the pivot members 72 are rotated by the output members 70 about the pivot axis 74. And each pivot member 72 is also connected to a respective one of the steering links 58 at a location spaced from the pivot axis 74 and opposite to the connection to the respective output member 70. In this way, when the pivot members 72 are rotated about the pivot axis 74 by the actuator 66, the steering links 58 are pulled or pushed to change the steering angle of the rear wheels 16. The pivot members 72 are rotated together (i.e. at the same time), in the same direction (e.g. clockwise or counter-clockwise), at the same rate and so, by the same amount, to cause the same steering angle change in both rear wheels 16 together. When the rear of one wheel 16 is rotated outward, further from a fore-aft centerline of the vehicle, the rear of the other wheel 16 is rotated inward, closer to the fore-aft centerline of the vehicle, and vice versa.

In at least some implementations, the pivot members 72 are links or rods/bars that are connected to a pivot mount 76 for rotation about the pivot axis 74. The pivot members 72 may each be rotated midway between the connection points to the steering link 58 and actuator output member 70, or the pivot axis 74 may be other than equidistant to the connection points to provide a mechanical advantage, as desired.

In at least some implementations, such as is shown in FIG. 4, the pivot member 72 is connected to the cradle 14 by a bracket 78 that is secured to the cradle 14 at three locations. The bracket 78 may be coupled near opposite ends by bolts 80 (and a suitable bushing or bearing to permit rotational couplings thereto), a central bolt/connector between the bolts 80 may define the pivot axis 74. The pivot mount 76 extends through an opening in the pivot member 72 and is coupled at one end to the cradle 14 and at its other end to the bracket 78. The pivot mount 76 may include a central shank and may be threaded at one or both ends to facilitate connection to the cradle 14 and bracket 78. The bracket 78 may be of any construction and arrangement to couple the pivot member 72 to the cradle 14, and permit pivoting motion of the pivot member 72 relative to the bracket 78. In the example shown, the bracket 78 is a metal plate that may be bent to accommodate movement of the pivot member 72, or spacers may be provided on the bolts to provide a gap 82 (FIG. 2) between the bracket 78 and cradle 14 in which the pivot member 72 can move.

As shown in FIG. 4, the pivot members 72 may be oriented for rotation in a plane 84 that extends in the fore-aft and cross-car directions (e.g. perpendicular to the vertical direction), with the pivot axis 74 arranged vertically and the axis 68 of the actuator arranged in the cross-car direction. As shown in FIG. 5, a bearing or bushing 86 may be provided between the pivot mount 76 and the pivot member 72, if desired. Also in the example shown in FIG. 5, suitable washers, fasteners 88 and the like are used for to couple the pivot mount 76 to the cradle, and no bracket 78 is provided.

In at least some implementations, the traction motor 12 and related components (i.e. a traction motor assembly 12) take up significant space between the wheels 16 and, to be arranged generally inline with the axis of rotation 50 of the wheels 16, the traction motor assembly 12 intersects the axis of rotation 50 and extends some distance both forward and rearward from the axis 50 (e.g. in the fore-aft direction). The traction motor assembly 12 may also lie between the connection points of the steering links 58 to the wheel mounts 46, such as by intersecting an imaginary line 90 (FIG. 3) drawn between the connection points in the cross-car direction 32. Thus, the steering actuator 66 needs to be mounted offset from the imaginary line 90, and offset from the steering link 58 connections to the wheel mounts 46.

In at least some implementations, the steering actuator 66 is positioned behind, in the fore-aft direction, the axis of rotation 50, and may be behind the imaginary line 90 through the connection points of the steering links 58 to the wheel mounts 46. In at least some implementations, the actuator 66 is mounted to the rear rail 24 of the cradle 14 and to a bottom surface 92 (FIG. 3) of the cradle 14 (e.g. a surface facing toward the ground). The actuator 66 could be located to the side or top of the cradle 14 in different applications, if desired. The actuator 66 may include a housing with flanges that can be bolted to the cradle 14, for example. The torsion bar 60 may overlap, in the fore-aft and cross-car directions, the actuator 66, and in the illustrated example, the torsion bar 60 extends adjacent to the rear side of the rear rail 24 of the cradle 14 and above the steering actuator 66.

In this arrangement, the pivot members 72 are arranged so that they extend a sufficient distance forward (in the fore-aft direction, toward the front of the vehicle), though the pivot axis 74 for connection to the steering links 58 at a location that enables the steering links 58 to be oriented at a desired angle relative to the wheels 16/wheel mounts 46. To maintain desired suspension performance attributes, in the illustrated implementation, the steering links 58 are arranged at an included angle of between five degrees and fifteen degrees relative to the imaginary line 90 or other line parallel to the axis of rotation 50 of the wheels 16. The connection of the steering links 58 to the wheel mounts 46 may be forward of the connection to the pivot members 72, and, in the fore-aft direction, the pivot axis 74 may be located between the actuator axis 68/output centerline and the connection of the steering links 58 to the pivot members 72. Referring to FIG. 4, to facilitate adjustment of the steering links 58, they may be provided in two parts, with a first part 94 connected to the wheel mount 46 and having an opposite, threaded end that is coupled to a second part 96 that is connected to the pivot member 72 (e.g. at a bushing and/or bearing). The second part 96 may include an internally threaded bore and threaded rotation of the parts of the steering link changes the effective length between the ends of the steering link 58, as desired.

With the actuator 66 offset, the pivot member 72 may span between the actuator output members 70 and the steering links 58 to enable actuation of the steering links 58 by the actuator 66. The actuator 66 is operated to drive the steering links 58 to change the steering angle of the rear wheels 16 in accordance with control programming implemented by one or more controllers of the vehicle, and to supplement steering of the vehicle via the front wheels. While the actuator 66 is shown offset from the steering links 58 due to the presence of the traction motor assembly 12, other powertrain components (which may also include drivetrain components) may be arranged along or near the axis of rotation of the wheels, such as power take-off units, transfer case, differential, engine, transmission, and the like. The pivot members 72 may have a desired length to space between the actuator axis/centerline 68 and the steering links 58 to provide a desired actuation of the steering links 58 in a wide range of offset locations of the actuator 66.

What is claimed is:

1. A vehicle, comprising:
a support structure;
a first wheel mount and a second wheel mount each adapted to receive a separate one of two rear wheels of the vehicle for rotation about an axis of rotation;
a rear suspension assembly coupled between the support structure and the first wheel mount and the second wheel mount; and
a rear wheel steering assembly coupled to the support structure and to the first wheel mount and the second wheel mount, the rear wheel steering assembly including an actuator coupled to the support structure, a first steering link coupled to the first wheel mount and to a first pivot member, a second steering link coupled the second wheel mount and to a second pivot member, the first pivot member and the second pivot member are separately connected to the actuator and are rotatable about separate pivots, each pivot is located between the connections of the associated steering link and the actuator to the pivot member, wherein the actuator is coupled to the support structure at a location that is spaced in a fore-aft direction from the axis of rotation and the pivot members are oriented to space a distance in the fore-aft direction between an axis of movement of the actuator and the steering links, and the actuator is operable to change the angle of the first wheel mount and the second wheel mount relative to the support structure to provide rear wheel steering.

2. The vehicle of claim 1 wherein the actuator is coupled to the support structure at a location that is spaced rearwardly from the axis of rotation relative to the fore-aft direction.

3. The vehicle of claim 2 wherein the actuator is a linear actuator and the axis of movement extends in a cross-car direction that extends between a left side and a right side of the vehicle, and is perpendicular to the fore-aft direction.

4. The vehicle of claim 3 wherein the first pivot member is driven for rotation about a first pivot axis, the second pivot member is driven for rotation about a second pivot axis, and the first pivot axis and the second pivot axis are both perpendicular to the actuator axis of movement.

5. The vehicle of claim 4 wherein the first pivot axis and the second pivot axis are oriented perpendicular to the cross-car direction.

6. The vehicle of claim 4 wherein the first steering link is connected to the first pivot member at a location forward of the first pivot axis relative to the fore-aft direction, and the actuator is coupled to the first pivot member at a location rearward of the first pivot axis.

7. The vehicle of claim 6 wherein the first steering link is coupled to the first wheel mount at a location rearward of the axis of rotation of the first wheel mount, and the second steering link is coupled to the second wheel mount at a location rearward of the axis of rotation of the second wheel mount.

8. The vehicle of claim 1 wherein the support structure includes a left side rail extending in the fore-aft direction, a right side rail extending in the fore-aft direction, and a rear rail extending in the cross-car direction, and the rear suspension assembly includes a first suspension assembly having at least one first suspension link coupled to the left side rail and the first wheel mount, and the rear suspension assembly includes a second suspension assembly having at least one second suspension link coupled to the right side rail and the second wheel mount, and wherein the actuator is coupled to the rear rail at a location spaced from a line connecting a center of rotation of the first wheel mount and a center of rotation of the second wheel mount.

9. The vehicle of claim 8 which also includes a powertrain component carried by the support structure forward of the actuator.

10. The vehicle of claim 8 wherein the left side rail, the right side rail and the rear rail are integrated into a cradle, a cavity is defined at least partially by the rails and a powertrain component is received at least partially within the cavity and forward of the actuator.

11. The vehicle of claim 9 wherein the powertrain component is one or more than one traction motor that is coupled to the first wheel mount via a first shaft to drivingly rotate the first wheel mount, and the one or more than one traction motor is coupled to the second wheel mount via a second shaft to drivingly rotate the second wheel mount.

12. The vehicle of claim 6 which includes a bracket that is coupled to the support structure on opposite sides of the first pivot axis, and a pivot mount is coupled to the first bracket and defines the first pivot axis, and the first pivot member rotates relative to the bracket and in a space between the bracket and the support structure.

13. The vehicle of claim 12 wherein the pivot mount extends through an opening in the pivot member, one end of the pivot mount is coupled to the support structure and another end of the pivot mount is coupled to the bracket.

14. A vehicle, comprising:
a support structure having a front rail, a rear rail, a left side rail between the front rail and the rear rail, and a left side rail between the front rail and the rear rail and spaced in a cross-car direction from the left side rail;
a powertrain component that is coupled to the support structure and to the first wheel mount via a first shaft that rotates with the first wheel mount, and to the second wheel mount via a second shaft that rotates with the second wheel mount;
a first wheel mount and a second wheel mount each adapted to receive a separate one of two rear wheels of the vehicle for rotation about an axis of rotation;
a powertrain component that is coupled to the support structure and to the first wheel mount via a first shaft that rotates with the first wheel mount, and to the second wheel mount via a second shaft that rotates with the second wheel mount;
a rear suspension assembly coupled between the support structure and the first wheel mount and the second wheel mount; and
a rear wheel steering assembly coupled to the support structure and to the first wheel mount and the second wheel mount, the rear wheel steering assembly including a linear actuator coupled to the support structure, a first steering link coupled to the first wheel mount and to a first pivot member, a second steering link coupled the second wheel mount and to a second pivot member, the first pivot member and the second pivot member are separately connected to the linear actuator and are rotatable about separate pivots, each pivot is located between the connections of the associated steering link and the linear actuator to the pivot member, wherein the linear actuator is coupled to the support structure at a location that is spaced rearwardly from the power train component in a fore-aft direction, and the pivot members are oriented to span a distance in the fore-aft direction between an axis of movement of the linear actuator and the steering links, and the linear actuator is operable to change the angle of the first wheel mount and the second wheel mount relative to the support structure to provide rear wheel steering.

15. The vehicle of claim 14 wherein the left side rail, the right side rail, the front rail and the rear rail are integrated into a cradle, a cavity is defined at least partially by the rails and the powertrain component is received at least partially within the cavity.

16. The vehicle of claim 14 wherein the powertrain component is one or more than one traction motor that is coupled to the first wheel mount via the first shaft to drivingly rotate the first wheel mount, and the one or more than one traction motor is coupled to the second wheel mount via the second shaft to drivingly rotate the second wheel mount.

17. The vehicle of claim 14 which includes a first bracket that is coupled to the support structure on opposite sides of the first pivot axis, and a pivot mount is coupled to the first bracket and defines the first pivot axis, and the first pivot member rotates relative to the first bracket and in a space between the first bracket and the support structure.

18. The vehicle of claim 17 wherein the pivot mount extends through an opening in the pivot member, one end of the pivot mount is coupled to the support structure and another end of the pivot mount is coupled to the first bracket.
